(19) United States
(12) Patent Application Publication
(10) Pub. No.: US 2026/0358595 A1
(43) Pub. Date: Nov. 12, 2026

(54) CAMERA MODULE AND VEHICLE COMPRISING SAME

(71) Applicant: LG INNOTEK CO., LTD., Seoul (KR)

(72) Inventors: Jun Young LIM, Seoul (KR); Sung Jin PARK, Seoul (KR)

(21) Appl. No.: 19/117,321

(22) PCT Filed: Sep. 26, 2023
(86) PCT No.: PCT/KR2023/014928

§ 371 Date: Mar. 31, 2025

(30) Foreign Application Priority Data
Sep. 29, 2022 (KR) 10-2022-0124307

(51) Int. Cl. G02B 7/02; G02B 1/04; G03B 17/12; G03B 30/00; H04N 23/54; H04N 23/55

(52) U.S. Cl. CPC G02B 7/028; G02B 1/041; G02B 7/021; G03B 17/12; G03B 30/00; H04N 23/54; H04N 23/55

(57) ABSTRACT

A camera module disclosed in an embodiment of the invention includes a lens barrel extending from an upper portion to lower portion; a plurality of lenses aligned along an optical axis on the inside of the lens barrel; a substrate disposed below the lens barrel; an image sensor disposed on the substrate; a base holder with an inside to which the substrate is coupled; and a ring holder coupled to an outside of the lens barrel and an upper portion of the base holder, wherein the ring holder is disposed between the base holder and an outer locking protrusion of the lens barrel, the base holder may be made of a first metal material, and the ring holder may be made of a second metal material different from the first metal.

### TECHNICAL FIELD

An embodiment of the invention relates to a camera module and a vehicle having the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical Stability Control), EMS (Engine Management System), MDPS (Motor Driven Power Steering), etc. are controlled. Typically, ADAS may be implemented as an automatic parking system, a low-speed city driving assistance system, a blind spot warning system, and the like. Sensor devices for sensing the situation ahead in ADAS include GPS sensors, laser scanners, front radar, and Lidar, but the most representative one is the front camera for filming the front of the vehicle.

Recently, research on detection systems that detect the surroundings of the vehicle for driver safety and convenience is accelerating. The vehicle detection systems are used for various purposes, such as detecting objects around the vehicle to prevent collisions with objects that the driver does not recognize, as well as performing automatic parking by detecting empty spaces, and provide the most essential data for automatic vehicle control. In such a detection system, a method using a radar signal and a method using a camera are commonly used. Vehicle camera modules are built into front and rear surveillance cameras and black boxes in cars and are used to capture subjects in photos or videos. Since vehicle camera modules are exposed to the outside, photographing quality may deteriorate due to moisture and temperature. In particular, camera modules have a problem in that their optical characteristics change depending on the surrounding temperature and the material of the lens.

### DISCLOSURE

### Technical Problem

An embodiment of the invention may provide a camera module having a ring holder capable of compensating for a change in the optical axis distance BFL between an image sensor and a last lens within a lens barrel. An embodiment of the invention may provide a camera module capable of responding to a change in a distance between the image sensor and the last lens by separating a ring holder disposed on an outer circumference of the lens barrel and a base holder on a lower portion of the lens barrel.

An embodiment of the invention may provide a camera module in which a holder supporting the outer and lower portions of the lens barrel are separated into an outer portion and a bottom portion in terms of material and physical properties. An embodiment of the invention may provide a camera module having at least one inner barrel or/and at least one plastic lens disposed on an inner portion of the lens barrel. An embodiment of the invention may provide a mobile device and a vehicle having a camera module.

### Technical Solution

A camera module according to an embodiment of the invention comprises a lens barrel extending from an upper portion to lower portion; a plurality of lenses aligned along an optical axis on the inside of the lens barrel; a substrate disposed below the lens barrel; an image sensor disposed on the substrate; a base holder with an inside to which the substrate is coupled; and a ring holder coupled to an outside of the lens barrel and an upper portion of the base holder, wherein the ring holder is disposed between the base holder and an outer locking protrusion of the lens barrel, the base holder may be made of a first metal material, and the ring holder may be made of a second metal material different from the first metal.

According to an embodiment of the invention, at least one of the plurality of lenses is a plastic lens, and the at least one plastic lens may overlap the ring holder in a direction perpendicular to the optical axis. The plurality of lenses may include a glass lens and a plastic lens smaller than the number of the glass lens, and a number of plastic lenses may be disposed on the inside of the ring holder.

According to an embodiment of the invention, the base holder may be made of the same metal material as the lens barrel. The ring holder may be made of stainless steel, and the base holder may be made of aluminum. The upper portion of the base holder and the lower portion of the ring holder may be fastened to each other with screw threads.

According to an embodiment of the invention, the upper portion of the ring holder may be bonded to the outer locking protrusion of the lens barrel with an adhesive. The upper surface of the ring holder may have a concave groove in which a part of the adhesive is disposed.

A camera module according to an embodiment of the invention comprises: a lens barrel that penetrates from an upper portion to a lower portion; a plurality of lenses aligned along an optical axis on an inner side of the lens barrel; a substrate disposed under the lens barrel; an image sensor disposed on the substrate; an inner barrel disposed between a lens adjacent to the image sensor among the plurality of lenses and the lens barrel; a base holder having a first through hole on the inner side and a lower portion of the first through hole on which the substrate is disposed; and a ring holder having a second through hole into which a part of the lens barrel is inserted on an inside and coupled to the upper portion of the base holder, wherein the ring holder is disposed between the base holder and an outer locking protrusion of the lens barrel, and the base holder may be made of a first metal material, and the ring holder may be made of a second metal material different from the first metal.

According to an embodiment of the invention, a lens disposed on the inside of the inner barrel includes a plastic lens, and the inner barrel may be made of a plastic material. An upper end of the inner barrel may be located lower than an upper end of the ring holder.

According to an embodiment of the invention, a thermal expansion coefficient of the ring holder is lower than a thermal expansion coefficient of the base holder, and the ring holder may have a shape that does not vertically overlap with the lens barrel. The camera module may include a first fastening portion on an upper outer surface protruding from the base holder; and a second fastening portion disposed on a lower inner surface of the ring holder and fastened to the first fastening portion.

According to an embodiment of the invention, the upper end of the ring holder may be disposed in a range of 40% to 60% of a total length of the lens barrel based on the lower end of the lens barrel. The lower end of the ring holder may be disposed lower than the sensor side of the last lens closest to the image sensor arranged within the lens barrel. A cover glass may be included on the image sensor; and an optical filter may be included between the plurality of lenses and the cover glass.

A vehicle according to an embodiment of the invention may include the camera module disclosed above.

### Advantageous Effects

According to an embodiment of the invention, there is an effect that the design may be changed so that it can respond to the amount of movement of the BFL of the optical system with a ring holder. In addition, the amount of change in the BFL of the optical system can be compensated by compensating with a ring holder according to the amount of change in the BFL (Back focal length) of the optical system according to the temperature change. Therefore, the resolution of the camera module according to the temperature change may be maintained and the optical reliability of the camera module may be improved.

According to an embodiment of the invention, an inner barrel may be further disposed in the lens barrel to minimize stress and de-center of the plastic lens according to temperature changes. In addition, an inner barrel and heterogeneous lenses are provided in the lens barrel to maintain resolution according to temperature changes and to suppress temperature deformation. According to an embodiment of the invention, optical reliability of a camera module may be improved, and reliability of a camera device for a vehicle having the camera module may be improved.

### DESCRIPTION OF DRAWINGS

FIG. 1 is an example of a side cross-sectional view of a camera module according to an embodiment of the invention.

FIG. 2 is a partial enlarged view of the camera module of FIG. 1.

FIG. 3 is an exploded perspective view of the ring holder and base holder of the lens holder of FIG. 1.

FIG. 4 is an example of a vehicle having the camera module of FIG. 1.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

In addition, the terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected” , “coupled” or “joined” to another component, the description may include not only being directly connected, coupled or joined to the other component but also being “connected” , “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Additionally, several embodiments described below may be combined with each other, unless specifically stated that they cannot be combined with each other. Additionally, unless specifically mentioned, parts omitted from the description of one of several embodiments may be applied to the description of other embodiments.

In the description of the invention, a first lens refers to the lens closest to the object side, and the last lens refers to the lens closest to the image side (or sensor surface). The last lens may include a lens adjacent to the image sensor. Unless otherwise specified in the description of the invention, the units for lens radius, thickness/distance, TTL, etc. are all mm. In this specification, the shape of the lens is expressed based on the optical axis of the lens. For example, saying that the object side of the lens is convex or concave means that the object side of the lens is convex or concave around the optical axis, but does not mean that the area around the optical axis is convex or concave. Therefore, even if the object side of the lens is described as convex, the portion around the optical axis on the object side of the lens may be concave or the opposite shape. In this specification, it should be noted that the thickness and radius of curvature of the lens are measured based on the optical axis of the lens. In other words, a convex lens surface means that the lens surface in the area corresponding to the optical axis has a convex shape, and a concave lens surface means that the lens surface in the area corresponding to the optical axis has a concave shape, can do. In addition, “object-side surface” may refer to the surface of the lens facing the object side based on the optical axis, and “sensor-side surface” may refer to the surface of the lens facing the sensor side based on the optical axis.

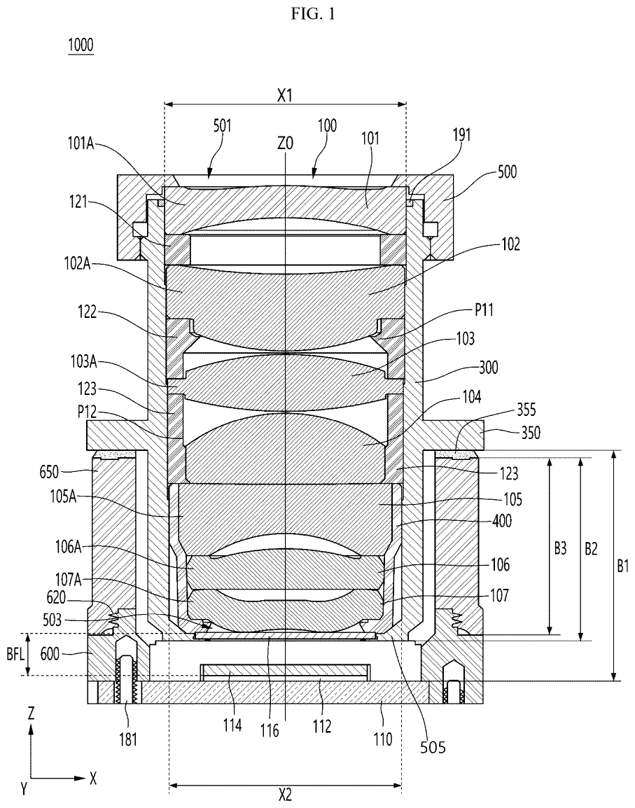

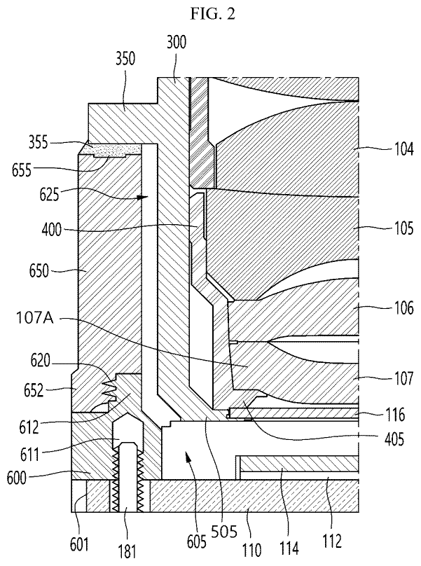

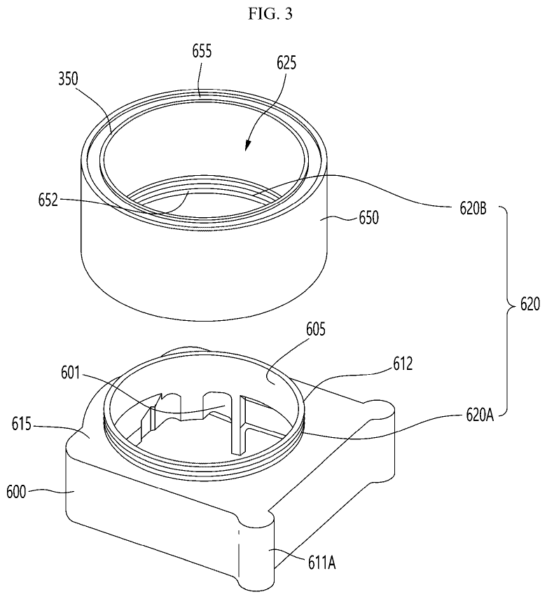

FIG. 1 is an example of a side cross-sectional view of a camera module according to an embodiment of the invention, FIG. 2 is a partially enlarged view of the camera module of FIG. 1, and FIG. 3 is an exploded perspective view of a ring holder and a base holder of the lens holder of FIG. 1. Referring to FIGS. 1 to 3, a camera module 1000 according to an embodiment of the invention may include a lens portion 100 having a plurality of lenses, a lens barrel 300 having a through hole therein and having a plurality of lenses stacked thereon, a ring holder 650 disposed on an outer periphery of the lens barrel 300, and a base holder 600 disposed on a bottom of the lens barrel 300 and the ring holder 650. The camera module 1000 may include at least one inner barrel 400 arranged on an inner portion of the lens barrel 300, and at least one space-maintaining member arranged on an outer side between the plurality of lenses. The inner barrel 400 may be penetrated from the upper portion to the lower portion. The cover 500 coupled to the upper portion of the lens barrel 300 may be included. The space-maintaining member may maintain a space between two adjacent lenses, and may function as a shade, a spacer, or a spacer.

The ring member 191 may be disposed around the circumference between the lens barrel 300 and the first lens 101 closest to the object. The ring member 191 may be made of an elastic material or a resin material such as silicone or epoxy. As another example, the ring member 191 may be coupled between the lens barrel 300 and the cover. The ring member 191 may perform a waterproof and dustproof function on the inner and/or outer side of the lens barrel 300. An additional ring member for sealing between the cover 500 and the lens barrel 300 may be further included.

The camera module 1000 may include a substrate 110 and an image sensor 112 disposed on the sensor side of the lens portion 100, that is, on the sensor side of the last lens. The camera module 1000 may include a cover glass 114 and an optical filter 116 between the last lens of the lens portion 100 and the image sensor 112.

The image sensor 112 may be disposed on the substrate 110. The substrate 110 may be mounted, fixed, in contact with, fixed, temporarily fixed, supported, or coupled to the image sensor 112 on a plane intersecting the optical axis Z0. Alternatively, according to another embodiment, a groove or hole (not shown) capable of accommodating the image sensor 112 may be formed on the substrate 110, and the embodiment is not limited to a specific form in which the image sensor 112 is arranged on the substrate 110. The substrate 110 may be a rigid PCB or FPCB. The image sensor 112 may perform a function of converting light passing through the lens portion 100 into image data. The image sensor 112 may be any one of a CCD (Charge coupled device) or a CMOS (Complementary metal-oxide semiconductor), CPD, or CID. When there are multiple image sensors 112, one may be a color (RGB) sensor and the other may be a black and white sensor. The optical filter 116 may be disposed between the lens portion 100 and the image sensor 112. The optical filter 116 may filter light corresponding to a specific wavelength range of light passing through the lenses 101-107. The optical filter 116 may be an infrared (IR) blocking filter that blocks infrared rays or an ultraviolet (UV) blocking filter that blocks ultraviolet rays, but the embodiment is not limited thereto. The optical filter 116 may be disposed on the image sensor 112. The cover glass 114 may be disposed between the optical filter 116 and the image sensor 112, and may protect the upper portion of the image sensor 112 and prevent the reliability of the image sensor 112 from being deteriorated.

The lens portion 100 may include an optical system in which five or more lenses are laminated, or an optical system in which nine or fewer lenses are laminated. The lens portion 100 may include six to eight solid lenses. All of the lenses of the lens portion 100 may be disposed as glass lenses, or all of them may be disposed as plastic lenses. The lens portion 100 may include lenses of different materials, and may include, for example, lenses made of plastic and lenses made of glass. For example, the lens portion 100 may include one or more plastic lenses and four or more glass lenses. The ratio of the number of lenses made of the plastic material to the number of lenses made of the glass material may include 1:2 to 2:5. As another example, the number of lenses made of the glass material may be greater than the number of lenses made of the plastic material.

In the lens portion 100 according to the embodiment of the invention, the number of lenses made of the glass material may be at least 2 more than the number of lenses made of the plastic material. Here, the lens portion 100 may be laminated with plastic lenses and/or glass lens(es). Here, the plastic material has a higher coefficient of linear thermal expansion (CTE) than the glass material, for example, 5 times higher, and the change value of the refractive index according to the function of temperature may be higher than the glass material, for example, 10 times higher. However, since the lenses made of the plastic material are easier to manufacture and more convenient to design than the lenses made of the glass material, the demand for their use is increasing.

The lens having the maximum effective diameter in the camera module 1000 may be a lens close to the object side, or one of the lenses between the two object-side lenses and the two sensor-side lenses. Preferably, the lens having the maximum effective diameter may be made of glass. The effective diameter may be the diameter of the effective region on which effective light is incident from each lens. The effective diameter is an average of the effective diameters of the object-side surface and the sensor-side surface of each lens. An embodiment of the invention can reduce the weight of the camera module by further mixing a plastic lens into the camera module 1000, can provide a lower manufacturing cost, can suppress deterioration of optical characteristics due to temperature change, and can allow various types of plastic lenses to replace glass lenses, and can facilitate polishing and processing of lens surfaces such as aspherical or free-form surfaces. Each of the lenses may include an effective region and an ineffective region. The effective area may be an area through which light incident on each of the lenses passes. That is, the effective region may be defined as an effective region or effective diameter in which incident light is refracted to implement optical characteristics. The ineffective region may be disposed around the effective region and may be defined as a flange portion. The ineffective region may be a region in which effective light is not incident from the plurality of lenses. That is, the ineffective region may be an area unrelated to the optical characteristics. In addition, an end of the ineffective region may be a region fixed to a barrel or the like that accommodates the lens.

The lens barrel 300 is penetrated from an upper portion to a lower portion, and a plurality of lenses are coupled inside it, and the plurality of lenses may be coupled through the upper opening of the lens barrel 300 or the opening 501 of the cover 500. The plurality of lenses may be sequentially stacked from the last lens 107 closest to the sensor side to the lens 101 closest to the object side. As another example, the lenses may be coupled from the sensor side toward the object side, or may be coupled in both directions. The lens closest to the object side may be the first lens 101, and the sensor-side lens closest to the optical filter 116 or the image sensor 112 may be the n-th lens or the last lens, and may be the seventh lens 107, and n may be an integer greater than or equal to 5, for example, one of 6, 7, 8, and 9.

The lens portion 100 may have multiple lenses aligned along the optical axis Z0 from the object side toward the image sensor 112, for example, a first lens 101, a second lens 102, a third lens 103, a fourth lens 104, a fifth lens 105, a sixth lens 106, and a seventh lens 107 may be aligned. The second lens 102 may be disposed between the first lens 101 and the third lens 103. The fourth lens 104 may be disposed between the third lens 103 and the fifth lens 105, and the sixth lens 106 may be disposed between the fifth lens 105 and the seventh lens 107.

The camera module 1000 according to the embodiment may include an aperture stop 121. The aperture stop 121 may control the amount of light incident on the optical system 1000. The aperture stop 121 may be positioned at a set position. For example, the aperture stop 121 may function as a first spacer that separates the first and second lenses 102 and 102 from each other at a perimeter between the first lens 101 and the second lens 102. As another example, the aperture stop 121 may be implemented with a light-blocking material coated on the surface of the first spacer. Alternatively, the perimeter of the sensor-side surface of the first lens 101 or the perimeter of the object-side surface of the second lens 102 may be coated with a light-blocking material to function as an aperture that controls the amount of light, and in this case, the first spacer may be provided separately.

The aperture stop 121 is disposed around the first and second lenses 101 and 102, may be in contact with the inner surface of the lens barrel 300, and may be provided in a ring shape. The aperture stop 121 may be made of a metal material or a non-metal material, and may be formed of, for example, aluminum material or plastic material.

For convenience of explanation, the invention will be described with seven lenses, and the lenses 101-107 in the lens barrel 300 will be described as being coupled from the sensor side toward the object side. The first lens 101 may have positive (+) or negative (−) refractive power on the optical axis Z0. The first lens 101 may have negative (−) refractive power. The first lens is arranged closest to the object side among the lenses, and may have, for example, a convex object-side surface and a concave sensor-side surface on the optical axis. Since the object-side surface of the first lens has a convex shape in the optical axis, the problem of external foreign substances or dust accumulating may be suppressed. In addition, the first lens may be formed of a maintenance material. The first lens may be provided in an injection-molded shape using a glass material, and the object-side surface and the sensor-side surface may be aspherical. The first lens 101 made of the glass material may reduce changes in the center position and the radius of curvature due to temperature changes according to the surrounding environment, and may protect the incident-side surface of the optical system 1000. In addition, the flange portion 101A of the first lens 101 may have a flat object-side surface, and the flat surface may block foreign substances from entering from the outside. In addition, since the first lens 101 is made of a mold material, the adhesion with the cover 500 may be improved.

A cover 500 is coupled to the upper circumference of the flange portion 101A of the first lens 101, and the cover 500 may be coupled to the upper circumference of the lens barrel 300.

The second lens 102 may have positive (+) or negative (−) refractive power on the optical axis Z0. The second lens 102 may have positive (+) refractive power. For example, the second lens may have a concave object-side surface and a convex sensor-side surface in the optical axis. Alternatively, the second lens 102 may have a meniscus shape convex toward the object side or a shape concave on both sides. The second lens may be formed of a plastic material or a glass material, and may be formed of a glass material, for example.

The third lens 103 may have positive (+) or negative (−) refractive power on the optical axis Z0. The third lens 103 may have positive (+) refractive power. The third lens 103 may have a convex object-side surface and a convex sensor-side surface on the optical axis. Alternatively, the third lens 103 may have a meniscus shape convex toward the sensor side or a concave shape on both sides. The third lens 103 may be formed of a plastic material or a glass material, for example, may be formed of a glass material.

The fourth lens 104 may have positive (+) or negative (−) refractive power on the optical axis Z0. The fourth lens 104 may have positive (+) refractive power. The fourth lens 104 may have a convex object-side surface and a concave sensor-side surface on the optical axis. Alternatively, the fourth lens 104 may have a meniscus shape convex toward the sensor side or a concave shape on both sides. The fourth lens 104 may be formed of a plastic material or a glass material, and may be formed of, for example, a glass material.

The fifth lens 105 may have positive (+) or negative (−) refractive power on the optical axis Z0. The fifth lens 105 may have negative (−) refractive power. The fifth lens 105 may include a plastic or glass material. For example, the fifth lens 105 may be provided of a glass material. The fifth lens 105 may have, for example, a convex object-side surface and a concave sensor-side surface on the optical axis. Alternatively, the fifth lens 105 may have a convex meniscus shape toward the sensor side or a concave shape on both sides.

The fourth lens 104 and the fifth lens 105 may be bonded. The sensor-side surface of the fourth lens 104 and the object-side surface of the fifth lens 105 may be bonded. The fourth and fifth lenses 104 and 105 may have opposite refractive powers. The composite refractive power of the fourth and fifth lenses 104 and 105 may have positive (+) refractive power. The product of the refractive power of the object-side lens of the bonded lens and the refractive power of the sensor-side lens may be less than 0. The product of the focal length of the object-side lens of the bonded lens and the focal length of the sensor-side lens may be less than 0. Accordingly, the aberration characteristics of the optical system may be improved. If the refractive powers of the two lenses of the bonded lens are the same, there is a limit to the improvement of aberration. The composite refractive power of the above-mentioned bonded lenses has positive refractive power, and the object-side third lens 103 and the sensor-side sixth lens 106 based on the above-mentioned bonded lenses may have positive refractive power. Accordingly, the third lens 103, the bonded lenses, and the sixth lens 106 may refract some of the incident light in the direction of the optical axis. The diameter of the fifth lens 105 may be larger than the diameter of the fourth lens 104, and the outer surface of the fourth lens 104 is spaced apart from the inner surface of the lens barrel 300, and the outer surface of the flange portion 105A of the fifth lens 105 may be in contact with the inner surface of the lens barrel 300.

The sixth lens 106 may have positive (+) or negative (−) refractive power on the optical axis Z0. The sixth lens 106 may have positive (+) refractive power. The sixth lens 106 may include a plastic or glass material. For example, the sixth lens 106 may be provided as a plastic material. The sixth lens 106 may have a convex object-side surface and a convex sensor-side surface on the optical axis. As another example, the sixth lens 106 may have a meniscus shape convex toward the object side, a meniscus shape convex toward the sensor side, or a shape that is concave on both sides. The seventh lens 107 may have positive (+) or negative (−) refractive power on the optical axis Z0.

The seventh lens 107 may have negative (−) refractive power. The seventh lens 107 may include a plastic or glass material. For example, the seventh lens 107 may be a plastic material. The seventh lens 107 may have a meniscus shape convex toward the object side on the optical axis. In contrast, the seventh lens 107 may have a convex meniscus shape toward the sensor on the optical axis Z0, or a concave shape on both sides. The seventh lens 107 may be a plastic lens closest to the image sensor 300. By arranging the plastic lens closest to the image sensor 112, the optical performance may be improved by the lens surface having an aspherical surface, thereby controlling the effect on aberration characteristics and resolution. In addition, by arranging the plastic lens as the lens closest to the image sensor 112, the lens may be insensitive to assembly tolerances compared to a glass lens. In other words, being insensitive to assembly tolerances means that even if the assembly is slightly different from the design during assembly, the optical performance may not be significantly affected.

In the lens portion 100, the glass lenses may be defined as a first lens group, and the plastic lens(es) may be defined as a second lens group. The optical axis distance of the first lens group is the optical axis distance from the object-side surface of the first lens 101 to the sensor-side surface of the fifth lens 105, and the optical axis distance of the second lens group is the optical axis distance from the object-side surface of the sixth lens 106 to the sensor-side surface of the seventh lens 107.

The second spacer 122 is a member that maintains the distance between the flange portions 102A and 103A between the second and third lenses 102 and 103. The second spacer 122 may be made of a metal or non-metal material, for example, aluminum or copper, or plastic. The inner protrusion P11 of the second spacer 122 may be combined into a step portion formed around the perimeter of the convex sensor-side surface of the second lens 102. The third spacer 123 may maintain a distance between the flange portions 103A and 105A of the third lens 103 and the fifth lens 105. The third spacer 123 may maintain a distance between the third lens 103 and the bonded lens. The third spacer 123 may be made of a metal or non-metal material, for example, aluminum or copper, or plastic. The third spacer 123 is arranged between the outer surface of the fourth lens 104 and the inner surface of the lens barrel 300, and its inner protrusion P12 may support the outer periphery of the fourth lens 104. When the second and third spacers 122 and 123 are made of a metal material, they may conduct heat transferred from the inner lenses to the lens barrel 300. That is, it can dissipate heat conducted through the flange portion of the glass lens. If the spacer 121, 122, and 123 is made of a metal material, it may include at least one of In, Ga, Zn, Sn, Al, Ca, Sr, Ba, W, U, Ni, Cu, Hg, Pb, Bi, Si, Ta, H, Fe, Co, Cr, Mn, Be, B, Mg, Nb, Mo, Cd, Sn, Zr, Sc, Ti, V, Eu, Gd, Er, Lu, Yb, Ru, Y and La. The oxide film may be an oxide material treated with black oxide or brown oxide using copper. Here, the lens barrel 300 may be made of a metal or non-metal material, and may be made of, for example, aluminum or copper. Accordingly, if the lens barrel 300 is made of metal, it can dissipate heat generated from the spacers 121, 122, and 123 and the flange portion of each lens, thereby preventing a decrease in reliability of optical characteristics due to temperature changes of the camera module exposed to the outside.

The lens barrel 300 may have an upper diameter X1 of the inner portion larger than a lower diameter X2. Here, the upper diameter X1 may be the maximum distance of the region facing the outer surface of the flange portion 101A of the first lens 101. The lower diameter X2 may be the maximum distance of the region facing the outer surface of the flange portion 107A of the last lens 107.

In an embodiment of the invention, an inner barrel 400 may be combined within the lens barrel 300. Each of the lens barrel 300 and the inner barrel 400 may have at least one different lens on the inside. Here, the inside of the lens barrel 300 may be in contact with the outer surfaces of at least two or three or more lenses. The inside of the inner barrel 400 may be in contact with the outer surfaces of at least one or more lenses. The inner barrel 400 may be an inner barrel arranged on a part of the inside of the lens barrel 300. For example, the inner barrel 400 may be disposed on the sensor side rather than the object side among the inner region of the lens barrel 300. The inner barrel 400 may be disposed on the outside of at least one lens arranged closest to the sensor side among the inner region of the lens barrel 300. The inner barrel 400 may be disposed on the lower locking protrusion 505 of the lens barrel 300.

The inner barrel 400 is arranged with a plastic material and can contract and expand together with the inner lens according to a temperature change. The inner barrel 400 may be disposed between the lens barrel 300 and an outer surface of at least one lens. The inner barrel 400 may be disposed between the lens barrel 300 and an outer surface of at least one plastic lens. The inner barrel 400 may be disposed between the lens barrel 300 and an outer surface of at least one plastic lens and at least one glass lens. The lens barrel 300 may be formed of a first material, and the inner barrel 400 may be formed of a second material. The first and second barrels 300 and 400 may be made of different materials. The first and second barrels 300 and 400 may have different thermal expansion coefficients.

The thermal expansion coefficient of the inner barrel 400 may be a material having a higher thermal expansion coefficient than that of the lens barrel 300. For example, the lens barrel 300 may be made of a metal, for example, aluminum, and the inner barrel 400 may be made of a non-metal, for example, resin or plastic. The lens barrel 300 may have a thermal expansion coefficient of less than 30, and the inner barrel 400 may have a thermal expansion coefficient of 50 or more. The difference in the thermal expansion coefficients of the first and second barrels 300 and 400 may be 20 or more. The inner barrel 400 may have a difference in the thermal expansion coefficient of the lens made of a plastic material of 3 or less, 2 or less, or the same.

The height of the inner barrel 400 may be less than 50% or less than 40% of the height of the lens barrel 300. The height of the inner barrel 400 is a vertical distance from the lower end to the upper end, and may be greater than the center thickness of the plastic lenses or the optical axis distance of the second lens group. The height of the inner barrel 400 may be greater than the sum of the center thicknesses of the plastic lenses and the center distance between the plastic lenses. For example, the height of the inner barrel 400 may be greater than the center thicknesses of the sixth and seventh lenses 106 and 107, and may be greater than the sum of the center thicknesses of the sixth and seventh lenses 106 and 107 and the center distance between the sixth and seventh lenses 106 and 107. The height of the inner barrel 400 may be higher than the top height of the flange portion 106A of the sixth lens 106. The height of the inner barrel 400 may be smaller than the optical axis distance of the first lens group and larger than the optical axis distance of the second lens group. The height of the inner barrel 400 may be smaller than the optical axis distance from the center of the object-side surface of the fifth lens 105 to the center of the sensor-side surface of the seventh lens 107. The height of the inner barrel 400 may be larger than the optical axis distance of two lenses adjacent to the image sensor and smaller than the optical axis distance of three lenses. The height of the inner barrel 400 may be 5 mm or more, for example, in the range of 5 mm to 20 mm or in the range of 10 mm to 20 mm. If the height of the inner barrel 400 is out of the above range, the camera module may become larger or cover the outer surface of the glass lens, which may cause problems due to temperature changes. If it is smaller than the above range, the plastic lenses 106 and 107 may not all be covered, or it may be difficult to guide the lower perimeter of the fifth lens 105 to be aligned on the sixth lens 106. The height of the lens barrel 300 is a height from the lower end to the upper end of the lens barrel 300 in the optical axis direction.

The lenses that come into contact with the inner surface of the inner barrel 400 may be two, three, or four or more lenses. For example, the lenses that come into contact with the inner surface of the inner barrel 400 may be the fifth to seventh lenses 105, 106, and 107. The inner surface of the inner barrel 400 may extend from the outer surface of the flange portion 105A of the fifth lens 105 to the outer surface of the flange portion 107A of the seventh lens 107. As another example, a plurality of inner barrels may be disposed between the outer surfaces of the lenses and the lens barrel 300. Each of the plurality of inner barrels may be disposed between the adjacent two lenses and on the outer surfaces of the adjacent two lenses to maintain a distance between the adjacent two lenses and separate them from the lens barrel.

The inner surface of the lens barrel 300 may be in contact with the outer surfaces of the lenses made of glass. The inner surface of the inner barrel 400 may be in contact with the outer surfaces of the lenses made of plastic. The inner surface 45 of the inner barrel 400 may be in contact with the outer surfaces of the flange portions 106A and 107A of the sixth and seventh lenses 106 and 107. The upper portion of the inner surface 45 of the inner barrel 400 may be in contact with the outer surface of the fifth lens 105. The material of the inner barrel 400 and the material of the sixth and seventh lenses 106 and 107 may be the same material, for example, a plastic material. The plastic material may expand more than the aluminum material at high temperatures (i.e., 85 degrees or higher), and may shrink less than the aluminum material at low temperatures (i.e., −40 degrees or lower). Accordingly, when the sixth and seventh lenses 106 and 107 expand or contract according to temperature changes, the inner barrel 400 may expand or contract, thereby suppressing the centers of the sixth and seventh lenses 106 and 107 from being misaligned. That is, the inner barrel 400 may minimize stress and decentering of the plastic lens(es) according to temperature changes. In addition, since the inner barrel 400 and the sixth and seventh lenses 106 and 107 have the same coefficient of thermal expansion, the inner barrel 400 may flow together to minimize the stress generated when the plastic lens expands at high temperatures, and can minimize the decenter with the glass lens generated when it contracts at low temperatures. This camera module 1000 may minimize the change in resolution due to temperature changes.

The lower end portion 405 of the inner barrel 400 extends to the sensor side of the flange portion 107A of the seventh lens 107, which is the last lens, and may separate the flange portion 107A of the seventh lens 107 from the locking protrusion 505 of the lens barrel 300. The inner surface of the inner barrel 400 facing the outer surface of the lenses may be provided in a form in which the upper width is wider than the lower width. In addition, the lower end portion 405 of the inner barrel 400 may be disposed between the flange portion 107A of the seventh lens 107, which is the last lens, and the optical filter 116. Accordingly, the optical filter 116 may be mounted on the locking protrusion 505 of the lens barrel 300 and may be bonded with an adhesive, and may be prevented from being detached by the inner barrel 400.

Meanwhile, a holder 600 and 650 may be coupled to the outer periphery of the lens barrel 300. The holder 600 and 650 may support the lens barrel 300 and may set the optical axis distance BFL between the last lens in the lens barrel 300 and the image sensor 112. The holder may include a base holder 600 and a ring holder 650 coupled to the upper portion of the base holder 600. That is, the holder is not a single body, but is arranged as two separate holders 600 and 650. The base holder 600 and the ring holder 650 may be connected to each other by a fastening portion 620. The camera module 1000 installed in the vehicle experiences a temperature change from a low temperature (e.g., −40 degrees) to a high temperature (e.g., 120 degrees), and accordingly, the lenses, lens barrels, etc. in the camera module shrink and expand. That is, the lenses shrink and expand more than the lens barrel 300, which can affect the optical characteristics. In addition, the plastic lens can shrink and expand more than the glass lens. Here, the shrinkage and expansion according to the temperature can occur not only in the direction orthogonal to the optical axis Z0, but also in the direction of the optical axis. If the holder is a single body, the resolution of the vehicle's camera module may change depending on the changing temperature from low to high temperature, and since no actuator is used on the outside of the lens barrel or holder, there is a limit to compensating for the change in resolution. In the case of such a single body holder, the optical axis distance BFL between the last lens and the image sensor is designed to match the fixed height (BFL) of the holder, so if the fixed height or internal optical axis distance BFL of the holder changes, it may cause the resolution to decrease.

In addition, when designing a lens, if the variation according to the temperature of the BFL and lens barrel is accurately known and designed, it may be compensated for on its own, but there is a problem that the movement amount of the BFL varies from company to company, and if a change in resolution occurs, it is difficult to control the BFL. In addition, the movement amount of the BFL of the optical system or lens according to the temperature change cannot be compensated for by the thermal expansion coefficient of the holder having a single body, so there is a problem that the resolution decrease cannot be resolved.

In an embodiment of the invention, the holder is separated into a base holder 600 and a ring holder 650, so that the amount of movement of the BFL of the optical system or lens portion according to temperature change may be responded to through the ring holder 650, thereby preventing a decrease in resolution. The base holder 600 has a first through hole 605 therein, and the lower portion of the first through hole 605 may have a circular or polygonal shape, for example, a polygonal shape, and the upper portion 612 may have a circular shape. A substrate 110 is arranged in the lower portion of the first through hole 605, and the substrate 110 may be fastened to a fastening groove 611 of the base holder 600 and a fastening member 181. The substrate 110 may have a circular or polygonal shape, and preferably, a polygonal shape. The image sensor 112 is disposed on the substrate 110, and the image sensor 112 may have a polygonal shape. A cover glass 114 may be combined on the image sensor 112 to protect the image sensor 112. The image sensor 112 and the cover glass 114 may face the optical filter 116 in the optical axis direction.

The optical axis distance BFL between the surface of the image sensor 112 and the last lens 107 may be a space where the cover glass 114 and the optical filter 116 are installed, and may be defined as the back focal length, which is the distance from the sensor side of the last lens 107 to the focus, and may be an optical reference distance. This BFL may change in the optical axis direction based on the upper surface of the substrate 110 or the surface of the image sensor 112 when the temperature changes from low temperature to high temperature. The upper portion 612 of the base holder 600 may protrude in the optical axis direction from the upper surface of the base holder 600 and may be provided with a first fastening portion 620A. The first fastening portion 620A may be a screw thread formed on the outer surface of the upper portion 612 of the base holder 600. The ring holder 650 may be coupled to the upper portion 612 of the base holder 600. The ring holder 650 may be provided with a second fastening portion 620B on the lower portion 652. The second fastening portion 620B may be a screw thread formed on the inner surface of the lower portion 652 of the ring holder 650. By coupling the second fastening portion 620B to the outer side of the first fastening portion 620A, the ring holder 650 may be coupled on the base holder 600. As another example, the first fastening portion 620A may have a screw thread on the inside, and the second fastening portion 620B may have a screw thread formed on the outside, so that the second fastening portion 620B may be fastened to the inside of the first fastening portion 620A. The first and second fastening portions 620A and 620B may be fastened as fastening portions 620 using an adhesive to prevent screw loosening.

The ring holder 650 may have a second through hole 625 having a circular shape therein, and the second through hole 625 may have an outer diameter larger than the lower outer diameter of the lens barrel 300. The lens barrel 300 may be inserted into the second through hole 625, that is, the lower portion of the lens barrel 300 may be inserted. The upper surface of the ring holder 650 may face the outer locking protrusion 350 of the lens barrel 300. The ring holder 650 and the outer locking protrusion 350 may be spaced apart from each other by a predetermined distance, and an adhesive 355 may be applied. The adhesive 355 may adhere the ring holder 650 and the locking protrusion 350. A concave groove 655 is arranged on the upper surface of the ring holder 650, and a portion of the adhesive 650 may be applied to the groove 655, thereby strengthening the adhesive strength between the ring holder 650 and the locking protrusion 350. Here, the height B1 of the ring holder 650 is the distance in the optical axis direction between the upper end and lower end, and may be smaller than or equal to the distance B2 in the optical axis direction between the lower end of the lens barrel 300 and the outer locking protrusion 350.

The position of the upper end of the ring holder 650 may be positioned lower than the center of the object-side surface of the fourth lens 104 and higher than the center of the sensor-side surface. The position of the upper end of the ring holder 650 may be positioned higher than the upper end of the inner barrel 400. The position of the upper end of the ring holder 650 may be positioned as a member for supporting the outer side of the lens barrel 300, and may be positioned at 30% or more of the total length of the lens barrel 300, for example, in the range of 30% to 70% or 40% to 60%, based on the lower end of the lens barrel. In addition, the position of the upper end of the ring holder 650 may be positioned lower than the center of the object-side surface of the bonded lens and higher than the center of the sensor-side surface. The distance B1 in the optical axis direction between the outer catch protrusion 350 of the lens barrel 300 from the upper surface of the substrate 110 may be smaller than the sum of BFL and B3. The position of the lower end of the ring holder 650 may be positioned lower than the center of the object-side surface of the last lens 107, for example, lower than the center of the sensor-side surface. The ring holder 650 may be disposed parallel to the outer side of the lens barrel 300. Accordingly, the ring holder 650 may be disposed so as not to overlap with the lens barrel 300 in the optical axis direction, so that vertical thermal expansion is easy and vertical height adjustment is possible.

The material of the base holder 600 may be a first metal material, for example, aluminum material or copper material. For example, the material of the base holder 600 and the lens barrel 300 may preferably include aluminum. The material of the ring holder 650 may be a second metal material, and may be a second metal material different from the first metal material of the base holder 600. The thermal expansion coefficient of the ring holder 650 may be lower than the thermal expansion coefficient of the base holder 600. The material of the ring holder 650 may include stainless steel. The ring holder 650 may be easily replaced within the camera module 1000.

Therefore, the ring holder 650 may be provided in a shape that can contract and expand in the vertical direction according to the amount of change in the BFL in the camera module 1000. That is, the amount of change in BFL of the lens unit 1000 due to the temperature change is the amount of movement of BFL that occurs at high temperature or the amount of movement of BFL that occurs at low temperature, and may be the same as the amount of thermal expansion of the ring holder 650. Accordingly, the thermal compensation may be adjusted by the ring holder 650 according to the amount of BFL movement of the camera module 1000. In addition, the amount of movement of BFL due to the temperature change may be compensated for by using the ring holder 650 that is made of a different material from the base holder 600 and may move vertically. Since plastic lenses arranged in the lens barrel 300 are arranged inside the ring holder 650, the amount of vertical expansion may be greater than that of a glass lens. That is, at least one plastic lens can overlap the ring holder 650 in a direction orthogonal to the optical axis. The amount of change in BFL due to these plastic lenses may be compensated for by adjusting the height of the ring holder 650. The camera module 1000 can compensate or adjust the amount of movement of the BFL according to the amount of temperature change by combining the configurations of the lower end of the lens barrel 300, the base holder 600, and the ring holder 650 when optimizing the change in BFL according to the temperature change from high to low temperature.

Since the embodiment of the invention separates the base holder 600 and the ring holder 650 and then combines them, there is an effect that the design freedom of the ring holder 650, that is, the height of the ring holder 650 may be freely expanded or changed. Accordingly, the degree of freedom of optical design may be increased, and even if the amount of change in BFL according to the temperature is large, it may be adjusted by the height of the ring holder 650. In addition, even if the lenses have different materials or shapes according to the customer's request, the height of the ring holder 650 may be adjusted according to the amount of movement of the BFL. Therefore, it is possible to provide a holder that can respond to the minute and accurate change in BFL within the camera module. Additionally, the camera module sop may be replaced with a ring holder of a different height.

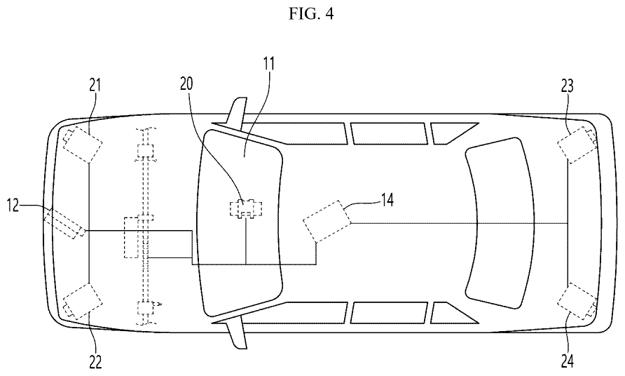

FIG. 4 is an example of a top view of a vehicle to which a camera module according to an embodiment of the invention is applied. Referring to FIG. 4, the vehicle camera system according to an embodiment of the invention includes an image generating unit 11, a first information generating unit 12, second information generating units 21, 22, 23, 24, and a control unit 14. The image generating unit 11 may include at least one camera module 20 disposed in the own vehicle, and may generate a front image of the own vehicle or an image inside the vehicle by photographing the front and/or driver of the own vehicle. In addition, the image generating unit 11 may generate an image captured by the driver or the surroundings of the own vehicle in one or more directions as well as in front of the own vehicle by using the camera module 20. Here, the front image and the surrounding image may be a digital image, and may include a color image, a black-and-white image, and an infrared image. In addition, the front image and the surrounding image may include a still image and a moving image. The image generating unit 11 provides the driver image, the front image, and the surrounding image to the control unit 14. Next, the first information generating unit 12 may include at least one radar and/or a camera disposed on the own vehicle, and generates first detection information by detecting the front of the own vehicle. Specifically, the first information generating unit 12 is disposed in the own vehicle, and generates the first sensing information by detecting the positions and speeds of vehicles located in front of the own vehicle, the presence and location of pedestrians, and the like.

By using the first detection information generated by the first information generating unit 12, it is possible to control to maintain a constant distance between the own vehicle and the vehicle in front, and the stability of vehicle operation may be improved in a preset specific case, such as when the driver wants to change the driving lane of the own vehicle or when reverse parking. The first information generating unit 12 provides the first detection information to the control unit 14. The second information generating unit 21, 22, 23, 24 detect each side of the own vehicle and generate second sensing information based on the front image generated by the image generating unit 11 and the first sensing information generated by the first information generating unit 12. Specifically, the second information generating units 21, 22, 23, and 24 may include at least one radar and/or camera disposed on the own vehicle, and detect the positions and speeds of vehicles located on the side of the own vehicle, or may take a video. Here, the second information generating units 21, 22, 23, and 24 may be disposed on both sides of the front and rear of the own vehicle, respectively.

Such the vehicle camera system may include the following camera module, and may protect the vehicle and objects from automatic driving or surrounding safety by providing or processing information obtained through the front, rear, each side or corner region of the own vehicle to the user. The optical system of the camera module according to the embodiment of the invention can be mounted in multiple units in a vehicle to enhance safety regulations, autonomous driving functions, and increase convenience. The optical system of the camera module according to an embodiment of the invention may be mounted in a vehicle for safety regulation, reinforcement of autonomous driving functions, and increased convenience. In addition, the optical system of the camera module is a part for control such as a lane keeping assistance system (LKAS), a lane departure warning system (LDWS), and a driver monitoring system (DMS), and is applied in a vehicle. Such a vehicle camera module may realize stable optical performance even when ambient temperature changes and provide a module with competitive price, thereby securing reliability of vehicle components.

Features, structures, effects, etc. described in the above embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although described above, this is only an example and does not limit the present invention, and those with ordinary knowledge in the field to which this invention belongs will see that various modifications and applications not illustrated above are possible without departing from the essential characteristics of this embodiment. For example, each component specifically shown in the embodiment may be modified and implemented. In addition, the differences related to these modifications and applications should be construed as being included in the scope of the invention defined in the appended claims.

1. A camera module comprising:
a lens barrel extending from an upper portion to a lower portion;
a plurality of lenses aligned along an optical axis on an inside of the lens barrel;
a substrate disposed below the lens barrel;
an image sensor disposed on the substrate;
a base holder with an inside to which the substrate is coupled; and
a ring holder coupled to an outside of the lens barrel and an upper portion of the base holder,
wherein the ring holder is disposed between the base holder and an outer locking protrusion of the lens barrel,
wherein the ring holder has a through hole therein,
wherein the through hole of the ring holder has an outer diameter larger than an outer diameter of the lower portion of the lens barrel.
wherein the base holder is made of a first metal material, and
wherein the ring holder is made of a second metal material different from the first metal.

2. The camera module of claim 1,
wherein at least one of the plurality of lenses is a plastic lens, and
wherein at least one plastic lens overlaps the ring holder in a direction perpendicular to the optical axis.

3. The camera module of claim 1,
wherein the plurality of lenses include a glass lens and a plastic lens smaller than a number of the glass lens, and
wherein a number of plastic lenses are disposed on an inside of the ring holder.

4. The camera module of claim 1,
wherein the base holder is made of the same metal material as the lens barrel.

5. The camera module of claim 4,
wherein the ring holder is made of stainless steel and the base holder is made of aluminum.

6. The camera module of claim 1,
wherein the upper portion of the base holder and a lower portion of the ring holder are fastened to each other with screw threads.

7. The camera module of claim 6, wherein an upper portion of the ring holder is bonded to the outer hooking protrusion of the lens barrel with an adhesive.

8. A camera module of claim 7, wherein an upper surface of the ring holder has a concave groove in which a part of the adhesive is disposed.

9. A camera module comprising:
a lens barrel that penetrates from an upper portion to a lower portion;
a plurality of lenses aligned along an optical axis on an inner side of the lens barrel;
a substrate disposed below the lens barrel;
an image sensor arranged on the substrate;
an inner barrel disposed between a lens adjacent to the image sensor among the plurality of lenses and the lens barrel;
a base holder having a first through hole on the inner side and a lower portion of the first through hole on which the substrate is disposed; and
a ring holder having a second through hole into which a part of the lens barrel is inserted on an inside and coupled to the upper portion of the base holder,
wherein the ring holder is disposed between the base holder and an outer locking protrusion of the lens barrel,
wherein the second through hole has an outer diameter larger than an outer diameter of the lower portion of the lens barrel,
wherein the base holder is made of a first metal material, and
wherein the ring holder is made of a second metal material different from the first metal.

10. The camera module of claim 9,
wherein the lens disposed on the inside of the inner barrel includes a plastic lens, and the inner barrel is made of a plastic material.

11. The camera module of claim 10,
wherein an upper end of the inner barrel is located lower than an upper end of the ring holder.

12. The camera module of claim 10,
wherein a thermal expansion coefficient of the ring holder is lower than a thermal expansion coefficient of the base holder, and
wherein the ring holder has a shape that does not overlap with the lens barrel in a vertical direction.

13. The camera module of claim 10, comprising:
a first fastening portion on an upper outer surface protruding from the base holder; and a second fastening portion disposed on a lower inner surface of the ring holder and fastened with the first fastening portion.

14. The camera module of claim 10,
wherein an upper end of the ring holder is disposed in a range of 40% to 60% of a total length of the lens barrel based on a lower end of the lens barrel, and
wherein a lower end of the ring holder is disposed lower than a sensor-side surface of a last lens that is closest to the image sensor disposed in the lens barrel.

15. A vehicle comprising:
a camera module according to claim 10, and
a lens barrel and the base holder are made of the same metal material.

16. The camera module of claim 13,
wherein the ring holder is moved in a direction of the optical axis based on the base holder by the first and second fastening portions.

17. The camera module of claim 1,
wherein an upper end of the ring holder is disposed in a range of 40% to 60% of a total length of the lens barrel based on a lower end of the lens barrel, and
wherein a lower end of the ring holder is disposed lower than a sensor-side surface of a last lens closest to the image sensor arranged in the lens barrel.

18. The camera module of claim 1,
wherein a lower portion of the ring holder and the base holder have fastening portions that are fastened to each other, and
wherein the ring holder is moved in a direction of the optical axis based on the base holder by the fastening portions.

19. The camera module of claim 18,
wherein an optical axis distance between a last lens adjacent to the image sensor within the plurality of lenses and the image sensor is adjusted by the ring holder.

20. The camera module of claim 1, comprising:
an optical filter coupled to an inner side of the lower portion of the lens barrel,
wherein an outer side of the lower portion of the lens barrel is inserted into the ring holder,
wherein the ring holder overlaps the optical filter and at least one lens adjacent to the image sensor among the plurality of lenses in a direction perpendicular to the optical axis.
